(19) United States
(12) Patent Application Publication
(10) Pub. No.: US 2026/0259796 A1
(43) Pub. Date: Sep. 3, 2026

(54) TRACKING CRC (CYCLIC REDUNDANCY CHECK) ERRORS PER MEMORY WRITE TRANSACTION

(71) Applicant: Intel Products IP LLC, Santa Clara, CA (US)

(72) Inventors: Christopher P. MOZAK, Portland, OR (US); James A. McCALL, Portland, OR (US)

(73) Assignee: Intel Products IP LLC, Santa Clara, CA (US)

(21) Appl. No.: 19/652,087

(22) Filed: Apr. 20, 2026

Related U.S. Application Data
(63) Continuation of application No. 19/090,252, filed on Mar. 25, 2025.
(60) Provisional application No. 63/569,506, filed on Mar. 25, 2024.

(51) Int. Cl. G06F 11/10; G06F 11/07

(52) U.S. Cl. CPC G06F 11/1004; G06F 11/073; G06F 11/0772

(57) ABSTRACT

A memory device includes CRC (cyclic redundance check) circuitry to detect CRC errors in write transactions. The CRC circuitry computes CRC for a data block to compare with CRC bits that were computed and sent by the memory controller. The memory device records the pass/fail status of write transactions in an error status register readable by the memory controller. The memory device can trigger the ALERT_n signal in response to an error.

### CLAIM TO PRIORITY

This Application is a continuation of and claims the benefit of and priority to U.S. application Ser. No. 19/090,252, entitled TRACKING CRC (CYCLIC REDUNDANCY CHECK) ERRORS PER MEMORY WRITE TRANSACTION, by Christopher P. Mozak, et al., filed Mar. 25, 2025, now pending, which claims the benefit of and priority to U.S. Provisional Application No. 63/569,506, filed Mar. 25, 2024.

### FIELD

Descriptions are generally related to memory subsystems, and more particular descriptions are related to write transactions to memory.

### BACKGROUND

As memory subsystem data rates and pin counts continue to increase to meet capacity/bandwidth targets, the ability of memory systems to meet overall BER (bit error rate) targets is becoming more difficult. CRC (cyclic redundancy check) can be used to retry read transactions to improve memory subsystem reliability. CRC is an error-detecting code typically applied in read transactions to ensure that the received data is error free.

A CRC-enabled memory controller includes a generator polynomial to calculate a CRC for a block of data to be written to a memory device, such as a DRAM (dynamic random access memory). The CRC-enabled memory controller appends the CRC to the block of data, forming a codeword. When the codeword is read from the memory, the memory controller computes CRC on the data block of the codeword and compares the computed CRC with the CRC stored in the codeword. If the computed CRC and the CRC stored in the codeword do not match, there is a data error in the block of data. The memory controller knows where the error exists and can perform another read of the block of data from memory to determine if the detected data error was a soft data error.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1 is a block diagram of an example of a system that monitors CRC errors for memory write transactions.

FIG. 2 is a block diagram of an example of a memory device with an error status register to store CRC error status for write transactions.

FIG. 3 is a timing diagram of an example of a memory device triggering an alert in response to a memory write CRC error.

FIG. 4 is a flow diagram of an example of process for tracking CRC errors for memory write transactions.

FIG. 5 is a block diagram of an example of a memory subsystem in which CRC error tracking for memory write transactions can be implemented.

FIGS. 6A-6B are block diagrams of an example of a CAMM system in which CRC error tracking for memory write transactions can be implemented.

FIG. 7 is a block diagram of an example of a computing system in which CRC error tracking for memory write transactions can be implemented.

FIG. 8 is a block diagram of an example of a multi-node network in which CRC error tracking for memory write transactions can be implemented.

Descriptions of certain details and implementations follow, including non-limiting descriptions of the figures, which may depict some or all examples, and well as other potential implementations.

### DETAILED DESCRIPTION

As described herein, a memory device includes CRC (cyclic redundance check) circuitry to detect CRC errors in write transactions. The CRC circuitry computes CRC for a data block to compare with CRC bits that were computed and sent by the memory controller. The memory device records the pass/fail status of write transactions in an error status register readable by the memory controller. The memory device can trigger the ALERT_n signal in response to an error.

Typical memory subsystems include multiple memory devices (e.g., DRAM (dynamic random access memory) devices) in a memory module. The typical implementation has a shared CA (command/address) bus, a data bus, and an ALERT_n signal line, which is a wired-OR pin connected to a daisy chain bus shared by the multiple memory devices. In one example, the ALERT_n signal is an asynchronous signal that a memory device asserts for multiple clock cycles.

As mentioned above, the memory device performs CRC monitoring with on-memory CRC circuitry. For each write transaction, the memory device writes the block of data to the memory core (e.g., a memory array) and writes the status (pass/fail) of the write transaction in an error status register. If the computed CRC for the received block of data and the CRC stored in the received codeword do not match, there is a data error in the block of data. In one example, the memory device reports the data error via an ALERT_n signal. The memory controller can trigger another write transaction to overwrite the codeword with the data error with a codeword without a data error.

In one example, with the error status register, the memory controller can know the specific write transaction that triggered the Alert signal. Instead of needing to retry the past N write transactions on the channel where the error was flagged, the system described can retry the specific write transaction with an error.

Consider a specific example of a memory subsystem that had a total latency of approximately 45 ns (nanoseconds). Assuming a memory bus transmission frequency of 16 GT/s (gigatransfers per second) with BL24 (burst length 24), the memory controller would need to retry approximately ((45×10\hat{ }−9)/(24/16×10\hat{ }9)), or (45*16/24)=30, which converted to the closest larger binary number is approximately 32 write transactions in the worst case scenario.

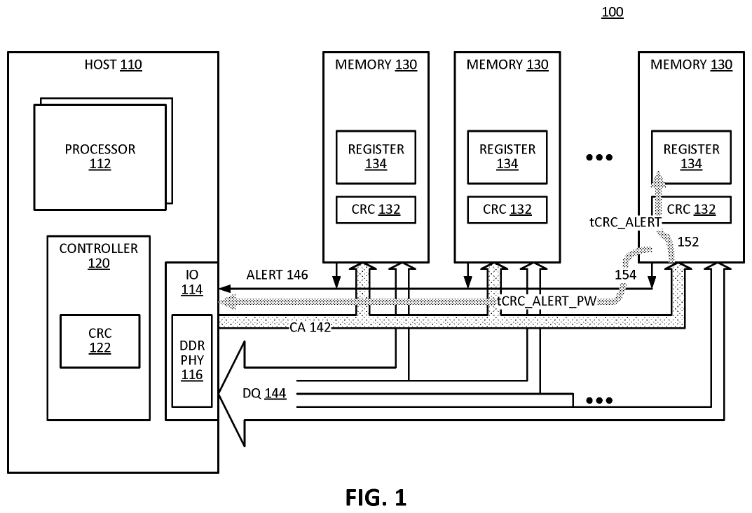

FIG. 1 is a block diagram of an example of a system that monitors CRC errors for memory write transactions. System 100 has a memory subsystem that monitors CRC errors. Host 110 includes controller 120 connected to memory 130.

Host 110 represents a computing system platform that executes a host OS (operating system) to control operations of the system. In one example, host 110 represents an SOC (system on a chip). Host 110 includes processor 112, which represents one or more processor devices. Host 110 includes controller 120, which represents a memory controller to manage access to memory 130. In one example, controller 120 is an integrated memory controller (iMC), integrated as a circuit on a processor die. In one example, controller 120 is a discrete chip or circuit die.

IO (input/output) 114 represents hardware interfaces to connections to memory 130. In one example, IO 114 includes DDR (double data rate) PHY (physical interface) 116. DDR PHY represents the hardware components to provide the command path and the data path from the host components to the hardware interfaces to the signal lines. In one example, at least part of IO 114 is part of controller 120.

In one example, system 100 includes three hardware interfaces between host 110 and memory 130. One interface is a CA (command/address) interface, represented by CA 142. In one example, CA 142 is a unidirectional multidrop bus shared by multiple memory devices. Another interface is the data (DQ) bus interface, represented by DQ 144. DQ 144 is a bidirectional point-to-point bus, with discrete data signal lines to each memory device. Another interface is the ALERT_n signal line, represented by Alert 146, which is a shared wired-OR signal line over which the memory devices can signal an error to host 110.

Memory 130 represents the memory devices. There can be a number, N, of memory dies that make up a memory channel, where a memory channel shares a CA bus. The memory devices can be SDRAM (synchronous dynamic random access memory) devices compatible with a DDR (double data rate) technology. For example, memory 130 cam represent DDR5 (double data rate version 5) SDRAMs. As another example, memory 130 can represent LPDDR6 (low power double data rate version 6) SDRAMs.

In one example, each memory 130 includes CRC hardware represented by CRC 132. CRC 132 is on-memory CRC circuitry. Controller 120 includes CRC 122, which represents CRC circuitry in the memory controller to generate CRC bits to send with a write data block. CRC 132 enables the memory devices to check write data for CRC errors.

It will be understood that Read CRC, or CRC checking on a read transaction, is fairly straightforward, seeing that the memory controller computes CRC with CRC 122 to check a specific data block, and thus knows exactly which cacheline needs to be retried. Write CRC, or CRC checking on a write transaction, is more complex since the memory device asserts the ALERT_N signal. With an accompanying setting of a mode register bit, the memory device can identify the memory channel and the memory device that triggered the error, but is unable to identify the specific transaction that triggered the error. Thus, the memory controller would need to resend all write transactions within a period of time (e.g., the last 32 write transactions, based on the analysis above).

In one example, memory 130 includes register 134, which represents an error status register to store the pass/fail status of write transactions. Thus, memory 130 can compute and check the CRC on-memory and then set a status in register 134. In one example, register 134 is an N-bit register, which can track pass/fail for N write transactions. Allowing controller 120 to read register 134, the memory controller can identify the specific write transaction that triggered the CRC error.

In one example, a write transaction in system 100 is executed by a two-cycle command, with a write command (command encoding for a write operation) followed by a CAS (column address strobe) command. The memory decodes the write command and executes it in response to the CAS command. In one example, in response to the CAS command, memory 130 computes CRC with CRC 132, as indicated at 152, and compares the computed CRC with the CRC bits to determine if there is a CRC error.

If there is no CRC error, memory 130 stores the data block in the memory core (not specifically illustrated) and stores a pass status in register 134 for the write transaction. The time to compute the CRC and record the status is tCRC_ALERT. If there is a CRC error, memory 130 stores the data block in the memory core and stores a fail status in register 134 for the write transaction. In one example, memory 130 also drives Alert 146, as illustrated at 154. The memory device drives the alert signal for a time tCRC_ALERT_PW, referring to the pulse width (PW) or the number of clock cycles the memory device drives the alert signal.

In one example, register 134 is an error status register that is an N-bit deep by 1-bit shift register in memory 130. Register 134 enables system 100 to track the specific write transaction in which the data error occurred. Thus, register 134 can track the CRC error status for N write transactions. By reading register 134, controller 120 can determine the specific write transaction with a CRC error.

In one example, the depth of a shift register implementation of register 134 can be determined by estimating the total round trip latency from when controller 120 generates the write CAS to when it sees the Alert signal on Alert 146. The total latency can be determined as the time it takes to send the write CAS, the propagation delay through DDR PHY 116, the time to send all UIs (unit intervals) of the burst length (BL) of the write, latency to cross the boundary from host 110 to the memory module, the memory performing a CRC check, asserting the Alert signal, controller 120 detecting the Alert signal, and then stopping traffic. The example of 45 ns was given above, but it will be understood that different system implementations will have different total latencies and different ratios of total latency to transfer speed. However, based on the example, it will be understood how to estimate the number of bits, N, needed in register 134.

In one example, in response to receiving the Alert signal, controller 120 can read register 134, such as by issuing an MRR (mode register read) command to cause memory 130 to return the contents of register 134. In one example, controller 120 identifies the specific memory device that generated the ALERT_n, and then issue the MRR to the identified memory device. With the contents of register 134, controller 120 can identify one or more write transactions that had CRC errors.

In one example, after reading register 134, controller 120 identifies specific write transaction(s) that had a CRC error based on a fail indication in the error status register. Controller 120 can then issue one or more retry write transactions, where the retry transaction is a repeat of a prior write transaction.

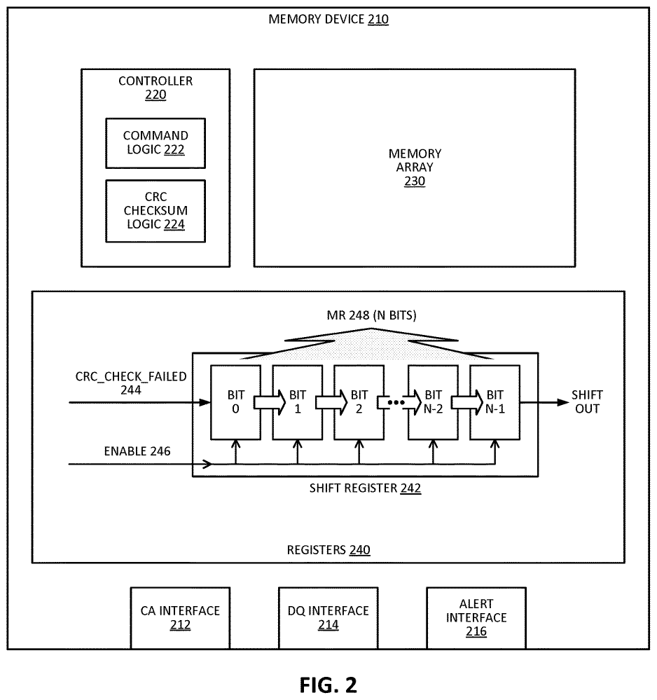

FIG. 2 is a block diagram of an example of a memory device with an error status register to store CRC error status for write transactions. Memory device 210 illustrates an example of a memory device in accordance with an example of memory 130 of system 100.

Memory device 210 includes memory array 230, which represents a memory core where the memory stores data. In response to a write command, memory device 210 writes data to memory array 230. In response to a read command, memory device 210 reads data from memory array 230.

Controller 220 represents hardware logic on memory device 210 to receive and process commands. Command logic 222 represents circuitry to decode commands received from the host. CRC checksum logic 224 represents CRC circuitry on memory device 210 to compute CRC on a data block received as part of a write transaction and compare the computed CRC to CRC bits received with the write data.

Memory device 210 includes multiple registers 240, which can be or include mode registers. Mode registers refer to registers that store status information and configuration information for the operations of memory device 210. In one example, registers 240 include shift register 242 or other error status register.

Shift register 242 represents multibit shift register (e.g., an N-bit deep) to track or store the CRC status (e.g., pass/fail information) of write transactions to memory array 230. In one example, the shift register is N-bit deep by 1-bit. When the error status register is implemented as a shift register, it can track the status of write transactions over a rolling window of N consecutive write transactions. For example, N can be 32 or any other number determined to store status for a sufficient number of write transactions to cover a period of time from when the memory controller issues a write to being able to stop traffic in response to a CRC error detected by the memory device for that write.

Shift register 242 is illustrated in a simplified fashion, with Bit 0, Bit 1, Bit 2, . . . , Bit N-2, and Bit N-1, with Bit 0 receiving the status (e.g., CRC_Check_Failed 244, or some other label), and all bits receiving enable 246. In one example, the CAS signal can operate as enable 246, to cause the individual bits to transfer their contents to the next register as Bit 0 receives a new bit, and Bit N-1 shifts out a bit.

In one example, each bit of shift register 242 represents a separate write transaction in a sequence of write transactions. While shift register 242 is represented as receiving an input at the LSB (least significant bit, Bit 0) and shift out at the MSB (most significant bit, Bit N-1), it will be understood that the logic can be reversed, with a new write transaction status being inputted to the MSB, and the register shifting down to the LSB, instead of receiving at the LSB and shifting to the MSB as illustrated.

It will be understood that memory device 210 can detect a CRC error and trigger the Alert signal, and will continue to add status for other write transactions through the entire latency period until the memory controller stops traffic. Thus, by the time the memory controller stops traffic, memory device 210 may have detected errors in subsequent write transactions after the one that initially prompts driving the alert signal line. In such a case, it can be expected that the write transaction with the CRC error that the memory device flags will be the MSB or close to the MSB (or the LSB, depending on system logic) by the time the memory controller reads shift register 242.

It will be understood that the system can be configured to provide the current bits of all portions of the shift register in response to a read of shift register 242. In one example, shift register 242 is read as a mode register, as represented by MR 248, which is an N-bit mode register in memory device 210. As a mode register, the memory controller can read MR 248 with an MRR (mode register read) command on the CA bus.

It will be understood that there may be other CRC errors that have occurred since that initial error detection. Thus, when reading shift register 242, the memory controller may be able to identify more than one write transaction that had a CRC error. The memory controller can retry any write transaction that had a CRC error, without having to retry all the write transactions in the sequence. In one example, being able to identify the specific write transactions with errors can allow the memory controller to at least partially reduce the write tracking queue structures of the memory controller (not specifically illustrated), because it can immediately drop any transaction older than a selected time (e.g., 45 ns according to the timing example provided above).

Memory device 210 includes CA (command/address) interface 212, which represents a hardware interface to the CA bus. Memory device 210 receives commands over the CA bus via CA interface 212, including a write command for a write transaction or a retry write transaction. In conjunction with a write command on the CA bus, the memory controller will send the write data and CRC bits on the data bus.

Memory device 210 includes DQ (data) interface 214, which represents a hardware interface to the DQ bus. Memory device 210 receives data over the DQ bus via DQ interface 214, including write data and CRC bits. For a write transaction, the memory controller generates a data block to be written to memory array 230 and CRC bits as a CRC check on the data bits.

In one example, memory device 210 includes alert interface 216, which represents a hardware interface to the alert signal line. Memory device 210 can drive the alert signal line with an Alert signal in response to various alert conditions. In one example, memory device 210 drives the alert signal line in response to detection of a CRC error in a write transaction by CRC checksum logic 224.

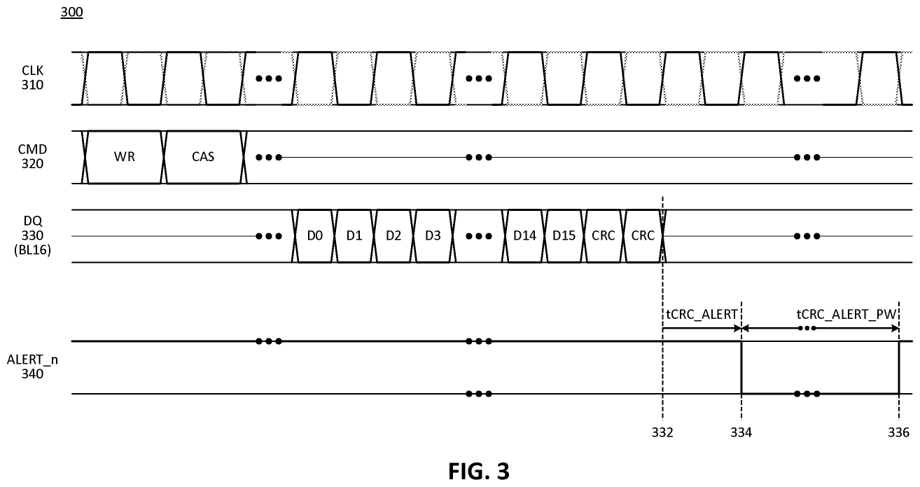

FIG. 3 is a timing diagram of an example of a memory device triggering an alert in response to a memory write CRC error. Diagram 300 illustrates a timing diagram for a system in accordance with an example of system 100.

CLK (clock) 310 represents a differential clock signal, which is the signal used to trigger command, address, and data information between the memory controller and the memory device. CMD 320 represents a command signal from the memory controller that carries command encoding including address information to cause the memory device to perform a memory access operation.

DQ 330 represents the DQ bus between the memory controller and memory device for the memory controller to send data for a write command and for the memory device to send data in response to a read command. ALERT_n 340 represents the alert signal line for the memory device to trigger an alert to the memory controller.

Diagram 300 illustrates the write operation followed by an alert signal based on a memory device detecting a CRC error in the write data. It will be understood that diagram 300 represents the operation with respect to one memory device, and thus, diagram 300 would represent operation for only a portion of the data. The full data write is provided to multiple memory devices in parallel.

In one example, each clock cycle of CLK 310 is a UI (unit intervals) for data transfer. As illustrated, the commands can be multiple UIs, where data is transferred on the rising and falling edge of the clock, or the rising edge of the clock and the rising edge of the complementary clock signal.

A burst can last for a configured number of UIs (e.g., a multi unit interval burst length), which can be a configuration stored in a register, or triggered on the fly. For example, a sequence of sixteen consecutive transfer periods can be considered BL16 (burst length sixteen), and the memory subsystem can transfer data on each UI.

In diagram 300, CMD 320 illustrates WR to represent a write command, followed by a CAS (column address strobe) to trigger the write. The write transaction can be defined by the write CAS. DQ 330 illustrates the write data that accompanies or is associated with the write command. In one example, there is a delay between the CAS command and the start of transferring the data. As illustrated, DQ 330 has a transfer of D15:D0, wherein D0, D1, . . . , represent the bits that will be presented to each DQ or data signal line of the memory device. For example, a x4 memory device operating on BL16 receives 64 bits of data for a write (4 data signal lines times 16 data bits transferred per line over the burst). It will be understood that this simple example is merely an illustration and is not limiting. In one example, two CRC bits are transmitted in addition to the 16 data bits (D15:D0) in the BL16.

At time 332, during a CRC alert delay time (tCRC_ALERT) the controller in the memory device checks for a CRC error in the received BL16 by comparing the transmitted CRC bits on DQ 330 with a computed CRC that it computes on the D15:D0. In one example, the tCRC_ALERT time can range from approximately 3 nanoseconds (ns) to 13 ns, which is nominally shown to last until time 334. The controller on the memory device stores a bit in the error status register based on the result of the comparison between the computed CRC and the received CRC bits.

At time 334, if the result of the comparison is a CRC fail, the memory device asserts ALERT_n 340. As illustrated, assertion of ALERT_n 340 is driving the signal line low (logic ‘0’) for a CRC alert pulse width time period (tCRC_ALERT_PW). In one example, the tCRC_ALERT_PW time can range from 12 to 30 periods of the system clock, CLK 310.

Upon detecting that the ALERT_n signal has been asserted to report a CRC error, the memory controller can determine the write transaction(s) that had a CRC error by reading the state of each bit (pass/fail) in the N-bit shift register in each memory device that shares the ALERT_n signal. At time 336, the memory device can stop asserting the alert signal by allowing ALERT_n 340 to return to a logic ‘1’.

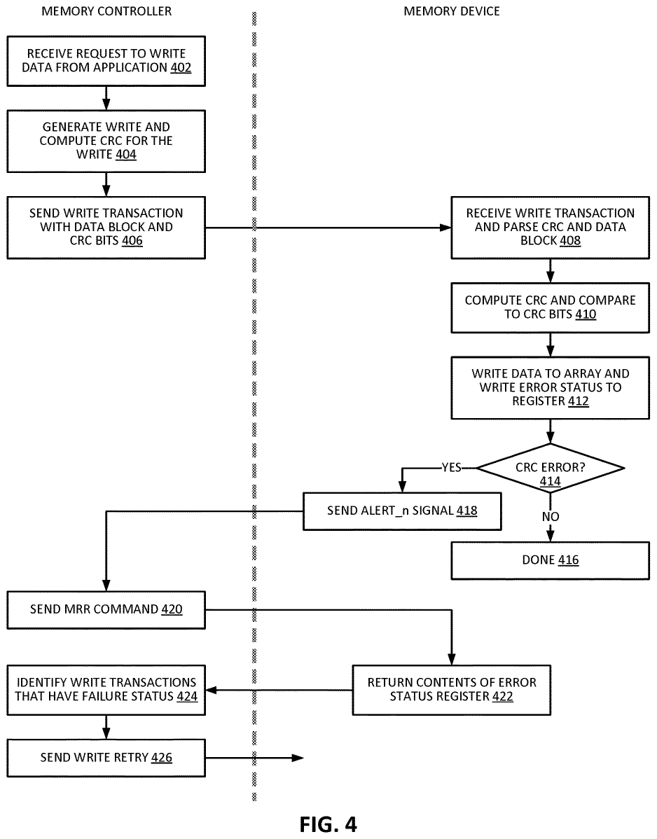

FIG. 4 is a flow diagram of an example of process for tracking CRC errors for memory write transactions. The memory controller and memory device can be in accordance with any example herein. Similar to what is described above, the flow represents the interaction between the memory controller and a memory device, but it will be understood that a typical memory subsystem has multiple memory devices in parallel.

The memory controller receives a request to write data to memory from an application or service or operating system component, block 402. The memory controller can generate a write command and compute the CRC for the write transaction, block 404. The memory controller can send the write transaction with the data block and the CRC bits, block 406.

The memory device receives the write transaction and parse the CRC bits and the data block from the write payload, block 408. In one example, circuitry on the memory device computes CRC based on the data block and compares the computed CRC to the CRC bits received in the write payload, block 410. The memory device writes the result of the comparison to the error status register and writes the data to the memory array, block 412.

In one example, if there is no CRC error, block 414 NO branch, the operation is done, block 416. In one example, if there is a CRC error, block 414 YES branch, the memory sends an ALERT_n signal to the memory controller, block 418.

The memory controller detects the alert signal. In one example, the memory controller sends an MRR command to read the error status register, block 420. The memory device processes the MRR command and returns the context of the error status register to the memory controller, block 422.

In one example, the memory controller can identify the one or more write transactions that have a CRC failure status, block 424. The memory controller can send write retries for the specific write transactions that have a CRC failure status, block 426.

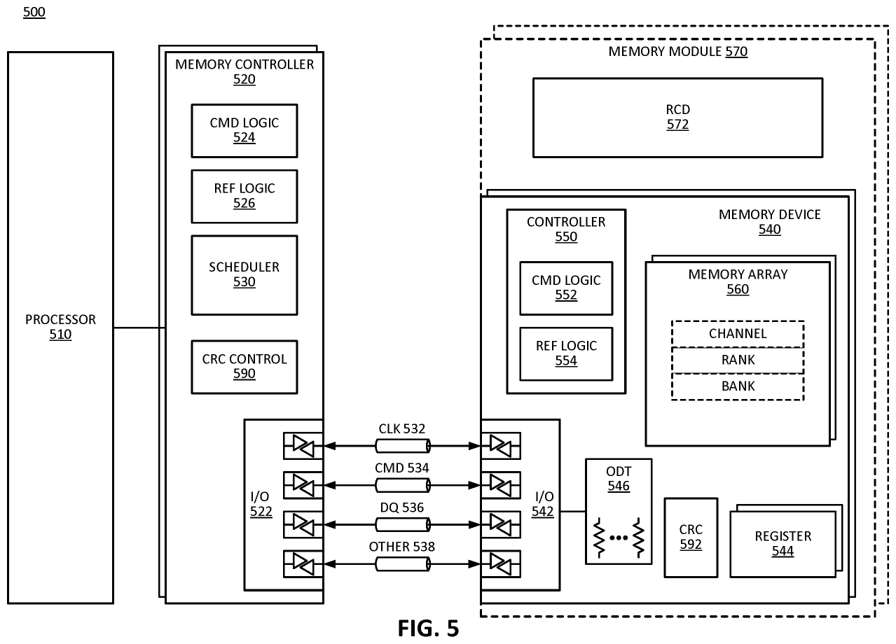

FIG. 5 is a block diagram of an example of a memory subsystem in which CRC error tracking for memory write transactions can be implemented. System 500 includes a processor and elements of a memory subsystem in a computing device. System 500 represents a system in accordance with an example of system 100.

In one example, system 500 performs write CRC monitoring. CRC control 590 in memory controller 520 represents logic in the memory controller to generate CRC for write transactions and send CRC bits with the data block to memory device 540. In one example, memory device 540 includes CRC 592, which represents CRC circuitry in the memory device to compute CRC on the data block and compare the computed CRC to the CRC bits received from the memory controller, in accordance with any example herein. In one example, the other signal lines 538 includes and alert signal line that memory device 540 can drive in response to detection of a CRC error. In one example, register 544 includes an error status register in accordance with any example herein.

Processor 510 represents a processing unit of a computing platform that may execute an operating system (OS) and applications, which can collectively be referred to as the host or the user of the memory. The OS and applications execute operations that result in memory accesses. Processor 510 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory accesses may also be initiated by devices such as a network controller or hard disk controller. Such devices can be integrated with the processor in some systems or attached to the processer via a bus (e.g., PCI express), or a combination. System 500 can be implemented as an SOC (system on a chip), or be implemented with standalone components.

Reference to memory devices can apply to different memory types. A memory device often refers to storage on a device with volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random-access memory), or some variant such as synchronous DRAM (SDRAM). A memory subsystem as described herein may be compatible with a number of memory technologies, such as DDR 5 (double data rate version 5, JESD79-5, originally published by JEDEC in July 2020), LPDDR 5 (LPDDR version 5, JESD209-5, originally published by JEDEC in February 2019), HBM2 (high bandwidth memory version 2, JESD235C, originally published by JEDEC in January 2020), HBM 3 (HBM version 3, JESD 238, originally published by JEDEC in January 2022), LPDDR 6 (LPDDR version 6, JESD209-6, currently in discussion by JEDEC), DDR 6 (DDR version 6, JESD79-6, currently in discussion by JEDEC), or others or combinations of memory technologies, and technologies based on derivatives or extensions of such specifications.

Memory controller 520 represents one or more memory controller circuits or devices for system 500. Memory controller 520 represents control logic that generates memory access commands in response to the execution of operations by processor 510. Memory controller 520 accesses one or more memory devices 540. Memory devices 540 can be DRAM devices in accordance with any referred to above. In one example, memory devices 540 are organized and managed as different channels, where each channel couples to buses and signal lines that couple to multiple memory devices in parallel. Each channel is independently operable. Thus, each channel is independently accessed and controlled, and the timing, data transfer, command and address exchanges, and other operations are separate for each channel. Coupling can refer to an electrical coupling, communicative coupling, physical coupling, or a combination of these. Physical coupling can include direct contact. Electrical coupling includes an interface or interconnection that allows electrical flow between components, or allows signaling between components, or both. Communicative coupling includes connections, including wired or wireless, that enable components to exchange data.

In one example, settings for each channel are controlled by separate mode registers or other register settings. In one example, each memory controller 520 manages a separate memory channel, although system 500 can be configured to have multiple channels managed by a single controller, or to have multiple controllers on a single channel. In one example, memory controller 520 is part of host processor 510, such as logic implemented on the same die or implemented in the same package space as the processor.

Memory controller 520 includes I/O interface logic 522 to couple to a memory bus, such as a memory channel as referred to above. I/O interface logic 522 (as well as I/O interface logic 542 of memory device 540) can include pins, pads, connectors, signal lines, traces, or wires, or other hardware to connect the devices, or a combination of these. I/O interface logic 522 can include a hardware interface. As illustrated, I/O interface logic 522 includes at least drivers/transceivers for signal lines. Commonly, wires within an integrated circuit interface couple with a pad, pin, or connector to interface signal lines or traces or other wires between devices. I/O interface logic 522 can include drivers, receivers, transceivers, or termination, or other circuitry or combinations of circuitry to exchange signals on the signal lines between the devices. The exchange of signals includes at least one of transmit or receive. While shown as coupling I/O 522 from memory controller 520 to I/O 542 of memory device 540, it will be understood that in an implementation of system 500 where groups of memory devices 540 are accessed in parallel, multiple memory devices can include I/O interfaces to the same interface of memory controller 520. In an implementation of system 500 including one or more memory modules 570, I/O 542 can include interface hardware of the memory module in addition to interface hardware on the memory device itself. Other memory controllers 520 will include separate interfaces to other memory devices 540.

The bus between memory controller 520 and memory devices 540 can be implemented as multiple signal lines coupling memory controller 520 to memory devices 540. The bus may typically include at least clock (CLK) 532, command/address (CMD) 534, and write data (DQ) and read data (DQ) 536, and zero or more other signal lines 538. In one example, a bus or connection between memory controller 520 and memory can be referred to as a memory bus. In one example, the memory bus is a multi-drop bus. The signal lines for CMD can be referred to as a “C/A bus” (or ADD/CMD bus, or some other designation indicating the transfer of commands (C or CMD) and address (A or ADD) information) and the signal lines for write and read DQ can be referred to as a “data bus.” In one example, independent channels have different clock signals, C/A buses, data buses, and other signal lines. Thus, system 500 can be considered to have multiple “buses,” in the sense that an independent interface path can be considered a separate bus. It will be understood that in addition to the lines explicitly shown, a bus can include at least one of strobe signaling lines, alert lines, auxiliary lines, or other signal lines, or a combination. It will also be understood that serial bus technologies can be used for the connection between memory controller 520 and memory devices 540. An example of a serial bus technology is 8B10B encoding and transmission of high-speed data with embedded clock over a single differential pair of signals in each direction. In one example, CMD 534 represents signal lines shared in parallel with multiple memory devices. In one example, multiple memory devices share encoding command signal lines of CMD 534, and each has a separate chip select (CS_n) signal line to select individual memory devices.

It will be understood that in the example of system 500, the bus between memory controller 520 and memory devices 540 includes a subsidiary command bus CMD 534 and a subsidiary bus to carry the write and read data, DQ 536. In one example, the data bus can include bidirectional lines for read data and for write/command data. In another example, the subsidiary bus DQ 536 can include unidirectional write signal lines for write and data from the host to memory, and can include unidirectional lines for read data from the memory to the host. In accordance with the chosen memory technology and system design, other signals 538 may accompany a bus or sub bus, such as strobe lines DQS. Based on design of system 500, or implementation if a design supports multiple implementations, the data bus can have more or less bandwidth per memory device 540. For example, the data bus can support memory devices that have either a x4 interface, a x8 interface, a x16 interface, or other interface. The convention “xW,” where W is an integer that refers to an interface size or width of the interface of memory device 540, which represents a number of signal lines to exchange data with memory controller 520. The interface size of the memory devices is a controlling factor on how many memory devices can be used concurrently per channel in system 500 or coupled in parallel to the same signal lines. In one example, high bandwidth memory devices, wide interface devices, or stacked memory configurations, or combinations, can enable wider interfaces, such as a x128 interface, a x256 interface, a x512 interface, a x1024 interface, or other data bus interface width.

In one example, memory devices 540 and memory controller 520 exchange data over the data bus in a burst, or a sequence of consecutive data transfers. The burst corresponds to a number of transfer cycles, which is related to a bus frequency. In one example, the transfer cycle can be a whole clock cycle for transfers occurring on a same clock or strobe signal edge (e.g., on the rising edge). In one example, every clock cycle, referring to a cycle of the system clock, is separated into multiple unit intervals (UIs), where each UI is a transfer cycle. For example, double data rate transfers trigger on both edges of the clock signal (e.g., rising and falling). A burst can last for a configured number of UIs, which can be a configuration stored in a register, or triggered on the fly. For example, a sequence of eight consecutive transfer periods can be considered a burst length eight (BL8), and each memory device 540 can transfer data on each UI. Thus, a x8 memory device operating on BL8 can transfer 64 bits of data (8 data signal lines times 5 data bits transferred per line over the burst). It will be understood that this simple example is merely an illustration and is not limiting.

Memory devices 540 represent memory resources for system 500. In one example, each memory device 540 is a separate memory die. In one example, each memory device 540 can interface with multiple (e.g., 2) channels per device or die. Each memory device 540 includes I/O interface logic 542, which has a bandwidth determined by the implementation of the device (e.g., x16 or x8 or some other interface bandwidth). I/O interface logic 542 enables the memory devices to interface with memory controller 520. I/O interface logic 542 can include a hardware interface, and can be in accordance with I/O 522 of memory controller, but at the memory device end. In one example, multiple memory devices 540 are connected in parallel to the same command and data buses. In another example, multiple memory devices 540 are connected in parallel to the same command bus, and are connected to different data buses. For example, system 500 can be configured with multiple memory devices 540 coupled in parallel, with each memory device responding to a command, and accessing memory resources 560 internal to each. For a Write operation, an individual memory device 540 can write a portion of the overall data word, and for a Read operation, an individual memory device 540 can fetch a portion of the overall data word. The remaining bits of the word will be provided or received by other memory devices in parallel.

In one example, memory devices 540 are disposed directly on a motherboard or host system platform (e.g., a PCB (printed circuit board) or substrate on which processor 510 is disposed) of a computing device. In one example, memory devices 540 can be organized into memory modules 570. In one example, memory modules 570 represent dual inline memory modules (DIMMs). In one example, memory modules 570 represent other organization of multiple memory devices to share at least a portion of access or control circuitry, which can be a separate circuit, a separate device, or a separate board from the host system platform. Memory modules 570 can include multiple memory devices 540, and the memory modules can include support for multiple separate channels to the included memory devices disposed on them. In one example, memory module 570 includes RCD (registering clock driver) 572 or other module logic device. When RCD 572 is included, it will be understood that at least some of the signal lines of I/O 542 would go through RCD 572. Additionally, if data buffers (not illustrated) are included, the DQ signal lines would connect to memory device 540 through the data buffers.

In another example, memory devices 540 may be incorporated into the same package as memory controller 520, such as by techniques such as multi-chip-module (MCM), package-on-package, through-silicon via (TSV), or other techniques or combinations. Similarly, in one example, multiple memory devices 540 may be incorporated into memory modules 570, which themselves may be incorporated into the same package as memory controller 520. It will be appreciated that for these and other implementations, memory controller 520 may be part of host processor 510.

Memory devices 540 each include one or more memory arrays 560. Memory array 560 represents addressable memory locations or storage locations for data. Typically, memory array 560 is managed as rows of data, accessed via wordline (rows) and bitline (individual bits within a row) control. Memory array 560 can be organized as separate channels, ranks, and banks of memory. Channels may refer to independent control paths to storage locations within memory devices 540. Ranks may refer to common locations across multiple memory devices (e.g., same row addresses within different devices) in parallel. Banks may refer to sub-arrays of memory locations within a memory device 540. In one example, banks of memory are divided into sub-banks with at least a portion of shared circuitry (e.g., drivers, signal lines, control logic) for the sub-banks, allowing separate addressing and access. It will be understood that channels, ranks, banks, sub-banks, bank groups, or other organizations of the memory locations, and combinations of the organizations, can overlap in their application to physical resources. For example, the same physical memory locations can be accessed over a specific channel as a specific bank, which can also belong to a rank. Thus, the organization of memory resources will be understood in an inclusive, rather than exclusive, manner.

In one example, memory devices 540 include one or more registers 544. Register 544 represents one or more storage devices or storage locations that provide configuration or settings for the operation of the memory device. In one example, register 544 can provide a storage location for memory device 540 to store data for access by memory controller 520 as part of a control or management operation. In one example, register 544 includes one or more Mode Registers. In one example, register 544 includes one or more multipurpose registers. The configuration of locations within register 544 can configure memory device 540 to operate in different “modes,” where command information can trigger different operations within memory device 540 based on the mode. Additionally or in the alternative, different modes can also trigger different operation from address information or other signal lines depending on the mode. Settings of register 544 can indicate configuration for I/O settings (e.g., timing, termination or ODT (on-die termination) 546, driver configuration, or other I/O settings).

In one example, memory device 540 includes ODT 546 as part of the interface hardware associated with I/O 542. ODT 546 can be configured as mentioned above, and provide settings for impedance to be applied to the interface to specified signal lines. In one example, ODT 546 is applied to DQ signal lines. In one example, ODT 546 is applied to command signal lines. In one example, ODT 546 is applied to address signal lines. In one example, ODT 546 can be applied to any combination of the preceding. The ODT settings can be changed based on whether a memory device is a selected target of an access operation or a non-target device. ODT 546 settings can affect the timing and reflections of signaling on the terminated lines. Careful control over ODT 546 can enable higher-speed operation with improved matching of applied impedance and loading. ODT 546 can be applied to specific signal lines of I/O interface 542, 522 (for example, ODT for DQ lines or ODT for CA lines), and is not necessarily applied to all signal lines.

Memory device 540 includes controller 550, which represents control logic within the memory device to control internal operations within the memory device. For example, controller 550 decodes commands sent by memory controller 520 and generates internal operations to execute or satisfy the commands. Controller 550 can be referred to as an internal controller, and is separate from memory controller 520 of the host. Controller 550 can determine what mode is selected based on register 544, and configure the internal execution of operations for access to memory resources 560 or other operations based on the selected mode. Controller 550 generates control signals to control the routing of bits within memory device 540 to provide a proper interface for the selected mode and direct a command to the proper memory locations or addresses. Controller 550 includes command logic 552, which can decode command encoding received on command and address signal lines. Thus, command logic 552 can be or include a command decoder. With command logic 552, memory device can identify commands and generate internal operations to execute requested commands.

Referring again to memory controller 520, memory controller 520 includes command (CMD) logic 524, which represents logic or circuitry to generate commands to send to memory devices 540. The generation of the commands can refer to the command prior to scheduling, or the preparation of queued commands ready to be sent. Generally, the signaling in memory subsystems includes address information within or accompanying the command to indicate or select one or more memory locations where the memory devices should execute the command. In response to scheduling of transactions for memory device 540, memory controller 520 can issue commands via I/O 522 to cause memory device 540 to execute the commands. In one example, controller 550 of memory device 540 receives and decodes command and address information received via I/O 542 from memory controller 520. Based on the received command and address information, controller 550 can control the timing of operations of the logic and circuitry within memory device 540 to execute the commands. Controller 550 is responsible for compliance with standards or specifications within memory device 540, such as timing and signaling requirements. Memory controller 520 can implement compliance with standards or specifications by access scheduling and control.

Memory controller 520 includes scheduler 530, which represents logic or circuitry to generate and order transactions to send to memory device 540. From one perspective, the primary function of memory controller 520 could be said to schedule memory access and other transactions to memory device 540. Such scheduling can include generating the transactions themselves to implement the requests for data by processor 510 and to maintain integrity of the data (e.g., such as with commands related to refresh). Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity, or other commands or a combination.

Memory controller 520 typically includes logic such as scheduler 530 to allow selection and ordering of transactions to improve performance of system 500. Thus, memory controller 520 can select which of the outstanding transactions should be sent to memory device 540 in which order, which is typically achieved with logic much more complex than a simple first-in first-out algorithm. Memory controller 520 manages the transmission of the transactions to memory device 540, and manages the timing associated with the transaction. In one example, transactions have deterministic timing, which can be managed by memory controller 520 and used in determining how to schedule the transactions with scheduler 530.

In one example, memory controller 520 includes refresh (REF) logic 526. Refresh logic 526 can be used for memory resources that are volatile and need to be refreshed to retain a deterministic state. In one example, refresh logic 526 indicates a location for refresh, and a type of refresh to perform. Refresh logic 526 can trigger self-refresh within memory device 540, or execute external refreshes which can be referred to as auto refresh commands) by sending refresh commands, or a combination. In one example, controller 550 within memory device 540 includes refresh logic 554 to apply refresh within memory device 540. In one example, refresh logic 554 generates internal operations to perform refresh in accordance with an external refresh received from memory controller 520. Refresh logic 554 can determine if a refresh is directed to memory device 540, and what memory resources 560 to refresh in response to the command.

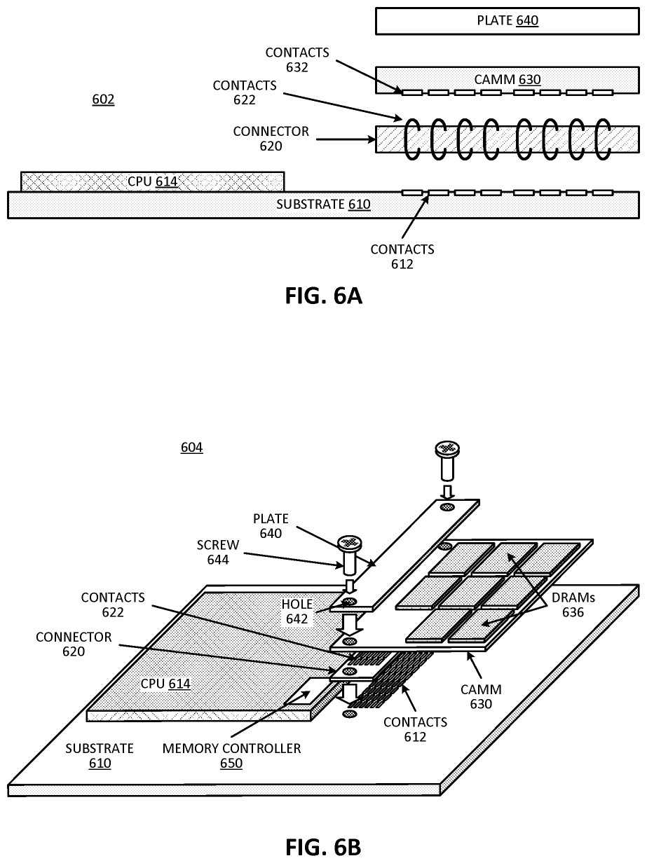

FIGS. 6A-6B are block diagrams of an example of a CAMM system in which CRC error tracking for memory write transactions can be implemented.

Referring to FIG. 6A, system 602 represents a system in accordance with an example of system 100. In one example, system 602 includes CRC circuitry in the memory to perform CRC monitoring on write transactions, in accordance with any example herein. In one example, the memory includes an error status register in accordance with any example herein.

Substrate 610 illustrates an SOC package substrate or a motherboard or system board. Substrate 610 includes contacts 612, which represent contacts for connecting with memory. CPU 614 represents a CPU (processor or central processing unit) chip or GPU (graphics processing unit) chip to be disposed on substrate 610. CPU 614 performs the computational operations in system 602. In one example, CPU 614 includes multiple cores (not specifically shown), which can generate operations that request data to be read from and written to memory. CPU 614 can include a memory controller to manage access to the memory devices.

CAMM (compression-attached memory module) 630 represents a module with memory devices, which are not specifically illustrated in system 602. Substrate 610 couples to CAMM 630 and its memory devices through CMT (compression mount technology) connector 620. Connector 620 includes contacts 622, which are compression-based contacts. The compression-based contacts are compressible pins or devices whose shape compresses with the application of pressure on connector 620. In one example, contacts 622 represent C-shaped pins as illustrated. In one example, contacts 622 represent another compressible pin shape, such as a spring-shape, an S-shape, or pins having other shapes that can be compressed.

CAMM 630 includes contacts 632 on a side of the CAMM board that interfaces with connector 620. Contacts 632 connect to memory devices on the CAMM board. Plate 640 represents a plate or housing that provides structure to apply pressure to compress contacts 622 of connector 620.

Referring to FIG. 6B, system 604 is a perspective view of a system in accordance with system 602. Memory controller 650 can include CRC logic and interface hardware to send write data to DRAMs 636 with the data block and CRC bits. In one example, DRAMs 636 include CRC logic to perform write CRC monitoring.

CAMM 630 is illustrated with memory chips or memory dies, identified as DRAMs 636 on one or both faces of the PCB of CAMM 630. DRAMs 636 are coupled with conductive contacts via conductive traces in or on the PCB, which couples with contacts 632, which in turn couple with contacts 622 of connector 620.

System 604 illustrates holes 642 in plate 640 to receive fasteners, represented by screws 644. There are corresponding holes through CAMM 630, connector 620, and in substrate 610. Screws 644 can compressibly attach the CAMM 630 to substrate 610 via connector 620.

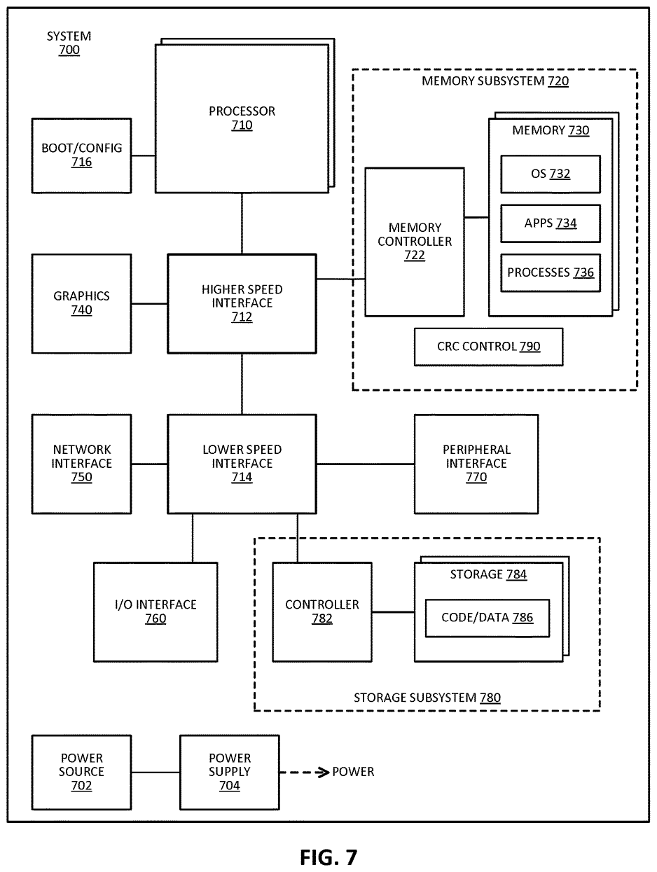

FIG. 7 is a block diagram of an example of a computing system in which CRC error tracking for memory write transactions can be implemented. System 700 represents a computing device in accordance with any example herein, and can be a laptop computer, a desktop computer, a tablet computer, a server, a gaming or entertainment control system, embedded computing device, or other electronic device.

System 700 represents a system in accordance with an example of system 100. In one example, system 700 performs write CRC monitoring. CRC control 790 represents circuitry in memory controller 722 and memory 730. CRC control 790 enables memory controller 722 to generate CRC for write transactions and send CRC bits with the data block to memory 730. In one example, CRC control 790 enables memory 730 to compute CRC on the data block and compare the computed CRC to the CRC bits received from the memory controller, in accordance with any example herein. In one example, memory 730 includes an error status register in accordance with any example herein.

System 700 includes processor 710 and can include any type of microprocessor, CPU (central processing unit), GPU (graphics processing unit), processing core, or other processing hardware, or a combination, to provide processing or execution of instructions for system 700. Processor 710 can be a host processor device. Processor 710 controls the overall operation of system 700, and can be or include, one or more programmable general-purpose or special-purpose microprocessors, DSPs (digital signal processors), programmable controllers, ASICs (application specific integrated circuits), PLDs (programmable logic devices), or a combination of such devices.

System 700 includes boot/config 716, which represents storage to store boot code (e.g., BIOS (basic input/output system)), configuration settings, security hardware (e.g., TPM (trusted platform module)), or other system level hardware that operates outside of a host OS. Boot/config 716 can include a nonvolatile storage device, such as ROM (read-only memory), flash memory, or other memory devices.

In one example, system 700 includes interface 712 coupled to processor 710, which can represent a higher speed interface or a high throughput interface for system components that need higher bandwidth connections, such as memory subsystem 720 or graphics interface components 740. Interface 712 represents an interface circuit, which can be a standalone component or integrated onto a processor die. Interface 712 can be integrated as a circuit onto the processor die or integrated as a component on a system on a chip. Where present, graphics interface 740 interfaces to graphics components for providing a visual display to a user of system 700. Graphics interface 740 can be a standalone component or integrated onto the processor die or system on a chip. In one example, graphics interface 740 can drive a display with high definition that provides an output to a user. In one example, the display can include a touchscreen display. In one example, graphics interface 740 generates a display based on data stored in memory 730 or based on operations executed by processor 710 or both.

Memory subsystem 720 represents the main memory of system 700, and provides storage for code to be executed by processor 710, or data values to be used in executing a routine. Memory subsystem 720 can include one or more varieties of RAM (random-access memory) such as DRAM, 3DXP (three-dimensional crosspoint), or other memory devices, or a combination of such devices. Memory 730 stores and hosts, among other things, OS (operating system) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710, such as integrated onto the processor die or a system on a chip.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a PCI (peripheral component interconnect) bus, a USB (universal serial bus), or other bus, or a combination.

In one example, system 700 includes interface 714, which can be coupled to interface 712. Interface 714 can be a lower speed interface than interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can exchange data with a remote device, which can include sending data stored in memory or receiving data to be stored in memory.

In one example, system 700 includes one or more I/O (input/output) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, NAND, 3DXP, or optical based disks, or a combination. Storage 784 holds code or instructions and data 786 in a persistent state (i.e., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (i.e., the value or state of the data is indeterminate if power is interrupted to system 700). In one example, storage subsystem 780 includes controller 782 to interface with storage 784. In one example controller 782 is a physical part of interface 714 or processor 710, or can include circuits or logic in both processor 710 and interface 714.

Power source 702 provides power to the components of system 700. More specifically, power source 702 typically interfaces to one or multiple power supplies 704 in system 700 to provide power to the components of system 700. In one example, power supply 704 includes an AC to DC (alternating current to direct current) adapter to plug into a wall outlet. Such AC power can be renewable energy (e.g., solar power) power source 702. In one example, power source 702 includes a DC power source, such as an external AC to DC converter. In one example, power source 702 or power supply 704 includes wireless charging hardware to charge via proximity to a charging field. In one example, power source 702 can include an internal battery or fuel cell source.

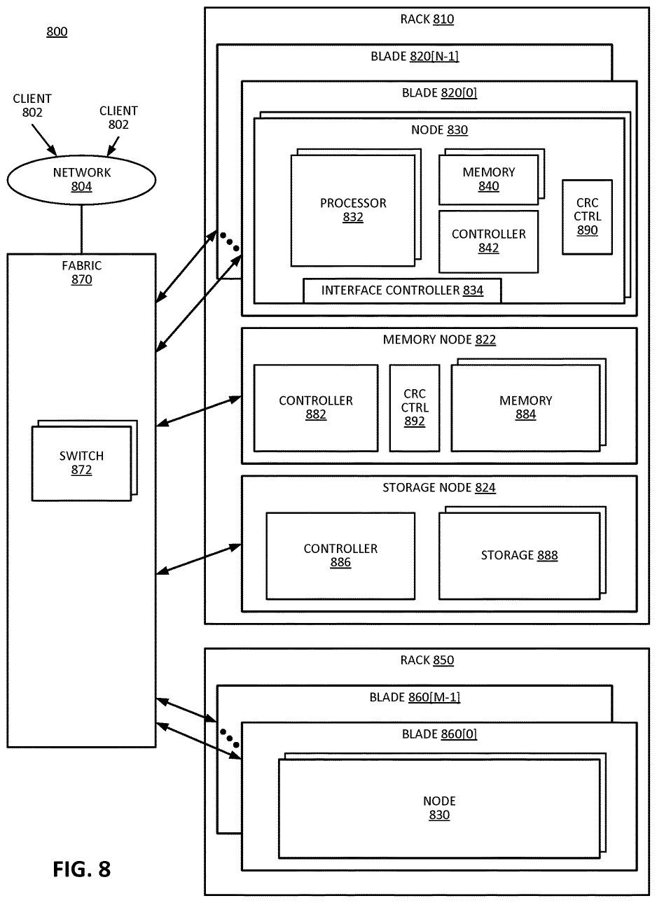

FIG. 8 is a block diagram of an example of a multi-node network in which CRC error tracking for memory write transactions can be implemented. In one example, system 800 represents a data center. In one example, system 800 represents a server farm. In one example, system 800 represents a data cloud or a processing cloud.

Nodes 830 of system 800 represent a system in accordance with an example of system 100. In one example, nodes of system 800 perform write CRC monitoring. CRC control (CTRL) 890 represents circuitry in controller 842 and memory 840. CRC control 890 enables controller 842 to generate CRC for write transactions and send CRC bits with the data block to memory 840. In one example, CRC control 890 enables memory 840 to compute CRC on the data block and compare the computed CRC to the CRC bits received from the memory controller, in accordance with any example herein. In one example, memory 840 includes an error status register in accordance with any example herein. CRC control 892 enables the same capabilities for controller 882 and memory 884 of memory node 822.

One or more clients 802 make requests over network 804 to system 800. Network 804 represents one or more local networks, or wide area networks, or a combination. Clients 802 can be human or machine clients, which generate requests for the execution of operations by system 800. System 800 executes applications or data computation tasks requested by clients 802.

In one example, system 800 includes one or more racks, which represent structural and interconnect resources to house and interconnect multiple computation nodes. In one example, rack 810 includes multiple nodes 830. In one example, rack 810 hosts multiple blade components, blade 820[0], . . . , blade 820[N-1], collectively blades 820. Hosting refers to providing power, structural or mechanical support, and interconnection. Blades 820 can refer to computing resources on printed circuit boards (PCBs), where a PCB houses the hardware components for one or more nodes 830. In one example, blades 820 do not include a chassis or housing or other “box” other than that provided by rack 810. In one example, blades 820 include housing with exposed connector to connect into rack 810. In one example, system 800 does not include rack 810, and each blade 820 includes a chassis or housing that can stack or otherwise reside in close proximity to other blades and allow interconnection of nodes 830.

System 800 includes fabric 870, which represents one or more interconnectors for nodes 830. In one example, fabric 870 includes multiple switches 872 or routers or other hardware to route signals among nodes 830. Additionally, fabric 870 can couple system 800 to network 804 for access by clients 802. In addition to routing equipment, fabric 870 can be considered to include the cables or ports or other hardware equipment to couple nodes 830 together. In one example, fabric 870 has one or more associated protocols to manage the routing of signals through system 800. In one example, the protocol or protocols is at least partly dependent on the hardware equipment used in system 800.

As illustrated, rack 810 includes N blades 820. In one example, in addition to rack 810, system 800 includes rack 850. As illustrated, rack 850 includes M blade components, blade 860[0], . . . , blade 860[M-1], collectively blades 860. M is not necessarily the same as N; thus, it will be understood that various different hardware equipment components could be used, and coupled together into system 800 over fabric 870. Blades 860 can be the same or similar to blades 820. Nodes 830 can be any type of node and are not necessarily all the same type of node. System 800 is not limited to being homogenous, nor is it limited to not being homogenous.

The nodes in system 800 can include compute nodes, memory nodes, storage nodes, accelerator nodes, or other nodes. Rack 810 is represented with memory node 822 and storage node 824, which represent shared system memory resources, and shared persistent storage, respectively. One or more nodes of rack 850 can be a memory node or a storage node.

Nodes 830 represent examples of compute nodes. For simplicity, only the compute node in blade 820[0] is illustrated in detail. However, other nodes in system 800 can be the same or similar. At least some nodes 830 are computation nodes, with processor (proc) 832 and memory 840. A computation node refers to a node with processing resources (e.g., one or more processors) that executes an operating system and can receive and process one or more tasks. In one example, at least some nodes 830 are server nodes with a server as processing resources represented by processor 832 and memory 840.

Memory node 822 represents an example of a memory node, with system memory external to the compute nodes. Memory nodes can include controller 882, which represents a processor on the node to manage access to the memory. The memory nodes include memory 884 as memory resources to be shared among multiple compute nodes.

Storage node 824 represents an example of a storage server, which refers to a node with more storage resources than a computation node, and rather than having processors for the execution of tasks, a storage server includes processing resources to manage access to the storage nodes within the storage server. Storage nodes can include controller 886 to manage access to the storage 888 of the storage node.

In one example, node 830 includes interface controller 834, which represents logic to control access by node 830 to fabric 870. The logic can include hardware resources to interconnect to the physical interconnection hardware. The logic can include software or firmware logic to manage the interconnection. In one example, interface controller 834 is or includes a host fabric interface, which can be a fabric interface in accordance with any example described herein. The interface controllers for memory node 822 and storage node 824 are not explicitly shown.

Processor 832 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory 840 can be or include memory devices represented by memory 840 and a memory controller represented by controller 842.

In general with respect to the descriptions herein, in one example, a memory device includes: a hardware interface to a command bus; a hardware interface to a data bus; on-memory CRC (cyclic redundancy check) circuitry to compute CRC on a data block of a write transaction received from a memory controller, the write transaction including a write command on the command bus and the data block and CRC bits on the data bus, the CRC circuitry to compare the computed CRC to the CRC bits; and an error status register to record a pass/fail status of the write transaction based on the comparison.

In one example of the memory device, the write transaction is defined by a write CAS (column address strobe), and the data block comprises data bits sent over a multi unit interval burst length. In accordance with any preceding example of the memory device, in one example, the error status register comprises a multibit shift register to store pass/fail information for N write transactions. In accordance with any preceding example of the memory device, in one example, the shift register has 32 bits to store the pass/fail information for 32 consecutive write transactions. In accordance with any preceding example of the memory device, in one example, in response to detection of a CRC error, the memory device is to set the LSB (least significant bit) of the error status register. In accordance with any preceding example of the memory device, in one example, the memory device includes: a hardware interface to an ALERT_n signal line between the memory device and the memory controller, wherein the hardware interface is to send an alert signal to the memory controller in response to detection of the CRC error. In accordance with any preceding example of the memory device, in one example, in response to the alert signal, the memory device is to receive an MRR (mode register read) command on the command bus, and return contents of the error status register on the data bus in response to the MRR command. In accordance with any preceding example of the memory device, in one example, in response to the alert signal, the memory device is to receive a retry write transaction for a write transaction having a fail indication in the error status register. In accordance with any preceding example of the memory device, in one example, the memory device is an SDRAM (synchronous dynamic random access memory) device.

In general with respect to the descriptions herein, in one example, a memory controller includes: a hardware interface to a command bus; a hardware interface to a data bus; CRC (cyclic redundancy check) circuitry to compute CRC bits on a data block for a write transaction; wherein the hardware interface to the command bus is to send a write command for the write transaction, and wherein the hardware interface to the data bus is to send the data block and the CRC bits to a memory device, the memory device to compute CRC on memory, compare the computed CRC to the CRC bits, and record a pass/fail status of the write transaction in an error status register, and wherein in response to an ALERT_n signal from the memory device, the hardware interface to the command bus is to send a command to read the error status register.

In one example of the memory controller, the write transaction is defined by a write CAS (column address strobe), and the data block comprises data bits sent over a multi-unit interval burst length. In accordance with any preceding example of the memory controller, in one example, the error status register comprises a multibit shift register to store pass/fail information for N write transactions. In accordance with any preceding example of the memory controller, in one example, the shift register has 32 bits to store the pass/fail information for 32 consecutive write transactions. In accordance with any preceding example of the memory controller, in one example, in response to detection of a CRC error, the memory device is to set the LSB (least significant bit) of the error status register. In accordance with any preceding example of the memory controller, in one example, the command to read the error status register comprises a MRR (mode register read) command. In accordance with any preceding example of the memory controller, in one example, in response to the ALERT_n signal, the memory device is to receive a retry write transaction for a write transaction having a fail indication in the error status register. In accordance with any preceding example of the memory controller, in one example, the memory device is an SDRAM (synchronous dynamic random access memory) device.

In general with respect to the descriptions herein, in one example, a first method for includes: receiving a write transaction at a memory device from a memory controller, the write transaction including a write command on a command bus and a data block and CRC bits on a data bus; computing CRC (cyclic redundancy check) with on-memory CRC circuitry at the memory device on the data block; comparing the computed CRC to the CRC bits; and recording a pass/fail status of the write transaction in an error status register based on the comparing.

In one example of the first method, the write transaction is defined by a write CAS (column address strobe), and the data block comprises data bits sent over a multi unit interval burst length. In accordance with any preceding example of the first method, in one example, the error status register comprises a multibit shift register to store pass/fail information for N write transactions. In accordance with any preceding example of the first method, in one example, the shift register has 32 bits to store the pass/fail information for 32 consecutive write transactions. In accordance with any preceding example of the first method, in one example, in response to detection of a CRC error, setting the LSB (least significant bit) of the error status register. In accordance with any preceding example of the first method, in one example, the method includes sending an alert signal on an ALERT_n signal line to the memory controller in response to detection of the CRC error. In accordance with any preceding example of the first method, in one example, in response to the alert signal, receiving an MRR (mode register read) command on the command bus, and returning contents of the error status register on the data bus in response to the MRR command. In accordance with any preceding example of the first method, in one example, in response to the alert signal, receiving a retry write transaction for a write transaction having a fail indication in the error status register. In accordance with any preceding example of the first method, in one example, the memory device is an SDRAM (synchronous dynamic random access memory) device.

In general with respect to the descriptions herein, in one example, a second method includes: computing CRC (cyclic redundancy check) bits on a data block for a write transaction; sending a write command on a command bus for the write transaction from a memory controller to the memory device; sending the data block and the CRC bits on a data bus to a memory device, the memory device to compute CRC on memory, compare the computed CRC to the CRC bits, and record a pass/fail status of the write transaction in an error status register, and wherein in response to an ALERT_n signal from the memory device; and sending a command to read the error status register.

In one example of the first method, the write transaction is defined by a write CAS (column address strobe), and the data block comprises data bits sent over a multi-unit interval burst length. In accordance with any preceding example of the second method, in one example, the error status register comprises a multibit shift register to store pass/fail information for N write transactions. In accordance with any preceding example of the second method, in one example, the shift register has 32 bits to store the pass/fail information for 32 consecutive write transactions. In accordance with any preceding example of the second method, in one example, in response to detection of a CRC error, the memory device is to set the LSB (least significant bit) of the error status register. In accordance with any preceding example of the second method, in one example, the command to read the error status register comprises a MRR (mode register read) command. In accordance with any preceding example of the second method, in one example, in response to the ALERT_n signal, sending a retry write transaction for a write transaction having a fail indication in the error status register. In accordance with any preceding example of the second method, in one example, the memory device is an SDRAM (synchronous dynamic random access memory) device.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A computing device comprising:
circuitry coupled to a memory, the circuitry to:
compute error detecting data bits on a data block associated with a write transaction; and
store the computed error detecting data bits in the memory, wherein the data bits are communicated over a multi-unit interval burst length, wherein the burst length is dynamically configurable.

2. The computing device of claim 1, wherein the circuitry is further to recompute, upon performance of a read transaction, the error detecting bits on the data block, and compare the recomputed error detecting bits with the stored error detecting bits associated with the write transaction.

3. The computing device of claim 1, wherein the circuitry comprises on-memory error detection code circuitry having an error status register to record a pass or fail status of the read transaction based on the comparison of the stored and recomputed error detecting bits, and, in response to detection of an error, transmit, via a hardware interface, an alert signal.

4. The computing device of claim 1, further comprising a Low Power Double Data Rate (LPDDR) memory device coupled to the circuitry, wherein the LPDDR includes an LPDDR6 and supports a Compression-Attacked Memory Module (CAMM) memory module, wherein the computed error detecting data bits along and the data block are received at the LPDDR device.

5. The computing device of claim 1, further comprising:
a first hardware interface associated with a command bus;
a second hardware interface associated with a data bus; and
a third hardware interface associated with an ALERT signal line, wherein the LPDDR memory device to write a Cyclic Redundancy Check (CRC) that is used to detect errors.

6. The computing device of claim 1, wherein the circuitry is coupled to processing circuitry having application processing circuitry.

7. A memory device comprising:
on-memory error detection code circuitry to:
compute error detecting data bits on a data block associated with a write transaction; and
store the computed error detecting data bits in a memory associated with the memory device, wherein the data bits are communicated over a multi-unit interval burst length, wherein the burst length is dynamically configurable.

8. The memory device of claim 1, wherein the on-memory error detection code circuitry is further to recompute, upon performance of a read transaction, the error detecting bits on the data block, and compare the recomputed error detecting bits with the stored error detecting bits associated with the write transaction.

9. The memory device of claim 1, wherein the on-memory error detection code circuitry comprises an error status register to record a pass or fail status of the read transaction based on the comparison of the stored and recomputed error detecting bits, and, in response to detection of an error, transmit, via a hardware interface, an alert signal.

10. The memory device of claim 1, further comprising a Low Power Double Data Rate (LPDDR) memory device coupled to the on-memory error detection code circuitry, wherein the LPDDR includes an LPDDR6 and supports a Compression-Attacked Memory Module (CAMM) memory module, wherein the computed error detecting data bits along and the data block are received at the LPDDR device.

11. The memory device of claim 1, further comprising:
a first hardware interface associated with a command bus;
a second hardware interface associated with a data bus; and
a third hardware interface associated with an ALERT signal line, wherein the LPDDR memory device to write a Cyclic Redundancy Check (CRC) that is used to detect errors.

12. The memory device of claim 1, wherein the circuitry is coupled to processing circuitry having application processing circuitry.

13. At least one computer-readable medium having stored thereon instructions which, when executed, cause a computing device to perform operations comprising:
computing, by circuitry of the computing device, error detecting data bits on a data block associated with a write transaction; and
storing the computed error detecting data bits in a memory, wherein the data bits are communicated over a multi-unit interval burst length, wherein the burst length is dynamically configurable.

14. The computer-readable medium of claim 13, wherein the operations further comprise recomputing, upon performance of a read transaction, the error detecting bits on the data block, and comparing the recomputed error detecting bits with the stored error detecting bits associated with the write transaction.

15. The computer-readable medium of claim 13, wherein the circuitry comprises on-memory error detection code circuitry having an error status register to record a pass or fail status of the read transaction based on the comparison of the stored and recomputed error detecting bits, and, in response to detection of an error, transmit, via a hardware interface, an alert signal.

16. The computer-readable medium of claim 13, wherein the computing device comprises a Low Power Double Data Rate (LPDDR) memory device coupled to the circuitry, wherein the LPDDR includes an LPDDR6 and supports a Compression-Attacked Memory Module (CAMM) memory module, wherein the computed error detecting data bits along and the data block are received at the LPDDR device.

17. The computer-readable medium of claim 13, wherein the computing device further comprises:
a first hardware interface associated with a command bus;
a second hardware interface associated with a data bus; and
a third hardware interface associated with an ALERT signal line, wherein the LPDDR memory device to write a Cyclic Redundancy Check (CRC) that is used to detect errors.

18. The computer-readable medium of claim 13, wherein the circuitry is coupled to processing circuitry having application processing circuitry.
